(19) United States
(12) Patent Application Publication
(10) Pub. No.: US 2015/0267581 A1
(43) Pub. Date: Sep. 24, 2015

(54) IN-SITUATION SCR CATALYST CLEANING PROCESS

(71) Applicant: Michael Patrick Ware, JR., Madison, IN (US)

(72) Inventor: Michael Patrick Ware, JR., Madison, IN (US)

(21) Appl. No.: 14/667,364

(22) Filed: Mar. 24, 2015

Related U.S. Application Data
(60) Provisional application No. 61/967,601, filed on Mar. 24, 2014.

(51) Int. Cl. F01N 3/023; B08B 5/02; B08B 5/04; B08B 7/02

(52) U.S. Cl. CPC F01N 3/0232; F01N 3/0233; B08B 7/02; B08B 5/02; B08B 5/04

(57) ABSTRACT

A vibration method of in situation cleaning of SCR catalyst units is disclosed. The system may include a hood that is designed to be manually positioned above the catalyst and pneumatic vibrators to be manually positioned under the catalyst layers to be used in concert with each other to manually clear the catalyst of built-up particle ash. The hood configuration blows and vacuums the ash from the top of the catalyst while the vibrators shake to ash loose from within the catalyst from the bottom of the catalyst modules.

### CROSS REFERENCE TO RELATED APPLICATIONS

This application claims priority to and the benefit thereof from U.S. Provisional Patent Application No. 61/967,601, filed Mar. 24, 2014 titled “IN-SITUATION SCR CATALYST CLEANING PROCESS,” the disclosure of which is hereby incorporated herein by reference in its entirety.

### BACKGROUND OF THE DISCLOSURE

1.0 Field of the Disclosure

The present disclosure relates generally to industrial emissions/equipment and cleaning thereof and, more particularly, to a system and method for SCR catalyst cleaning methods, among other features.

2.0 Related Art

Selective catalytic reduction (SCR) is a means of converting nitrogen oxides with the aid of a catalyst into diatomic nitrogen, N2, and water, H20. A gaseous reductant, typically anhydrous ammonia, aqueous ammonia, is added to a stream of flue or exhaust gas and is absorbed onto a catalyst. Carbon dioxide, is a reaction product when the ammonia is used as the reductant.

Commercial selective catalytic reduction systems are typically found on large utility boilers, industrial boilers, municipal solid waste boilers and, particularly, coal-fired power plants.

In Coal-fired power plant applications a “SCR UNIT” houses typically 2-3 layers of catalyst. Each layer of catalyst is made-up of catalyst modules and supported with an I-beam monorail system, or similar support structure. Flue gas containing fly ash passes through the catalyst layers, which causes the nitrogen oxides to react with the ammonia. The reaction causes the nitrogen to be converted to water vapor that is then released into the air. However, the design of an SCR system is challenged due to particulate in the fly ash that frequently causes the catalyst to become blocked/blinded thereby restricting the flow of gas through the catalyst and preventing optimal performance.

Current in-situation methods of maintaining SCR catalyst only include clearing the tops of the catalyst by merely vacuuming the ash off of the tops of the catalyst. However, current methods are not adequately preventing catalyst blockage/blinding. As the result, the catalyst often become severely clogged and eventually need to be removed manually to be cleaned and often, regenerated. All current methods of cleaning/unclogging catalyst, once preventive maintenance has failed, involve taking the boiler off-line, thereby preventing the plant for providing power to the grid.

Current EPA standards make SCR optimization more necessary than ever. Increasing demand for power prevents frequent plant shut down. Cost of plant shut down, removal of catalyst and catalyst cleaning is staggering in comparison to the methods introduced with this invention.

### SUMMARY OF THE DISCLOSURE

The present disclosure includes a method and/or system of cleaning the SCR unit, while the unit is on or off -line, and cleaning the SCR catalyst, in-situation. This disclosure provides a design or configuration of special equipment, including a hood that is designed to be manually positioned above the catalyst and pneumatic vibrators to be manually positioned under the catalyst layers to be used in concert with each other to manually clear the catalyst of built-up particle ash. The hood configuration blows and vacuums the ash from the top of the catalyst while the vibrators shake to ash loose from within the catalyst from the bottom of the catalyst modules.

In one aspect, a method for cleaning a selective catalytic reduction (SCR) unit is provided and includes the steps of positioning a hood above a catalyst module, the hood configured to blow air and configured to vacuum a top of the catalyst module and positioning and connecting a pneumatic vibrator under the catalyst module, wherein the hood and pneumatic vibrator operationally clear the catalyst module of built-up particle ash.

In one aspect, a system for cleaning a selective catalytic reduction (SCR) unit is provided comprising a hood configured to be positioned above one or more catalyst modules, a pneumatic vibrator configured to be configured under the one or more catalyst modules, wherein the hood is configured to apply air pressure to clean the one or more catalyst modules while the pneumatic vibrator is configured to simultaneously vibrate the one or more catalyst modules for cleaning the SCR unit.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the invention in more detail than may be necessary for a fundamental understanding of the disclosure and the various ways in which it may be practiced.

FIG. 1 is a prospective view of an example SCR reactor illustrating a three (3) layer catalyst unit, showing catalyst layers and I -beams under each layer of catalyst configured according to principles of the disclosure.

FIG. 2 is a drawing of an example hood that is configured to be placed over a catalyst basket, configured according to principles of the disclosure.

FIG. 3 is a drawing of an example catalyst module, configured accordant to principles of the disclosure.

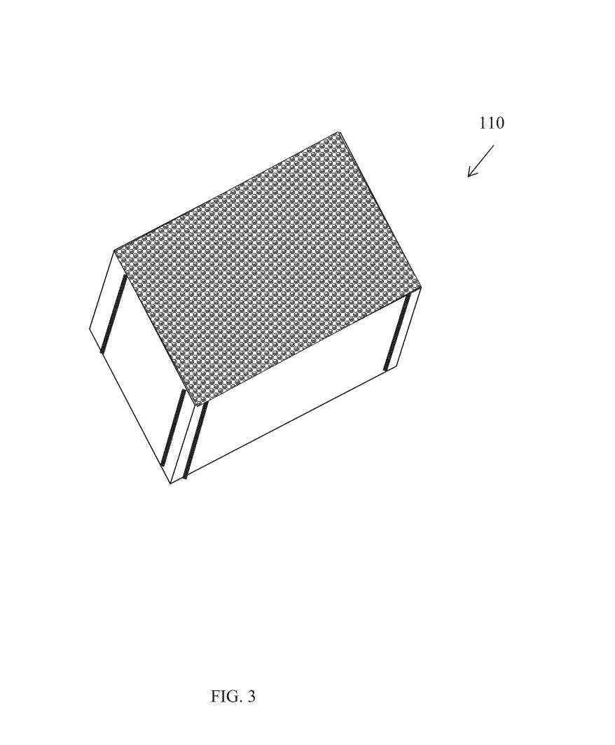

FIG. 4 is a drawing of example pneumatic vibrators that are configured to be bolted to the I-beams under the catalyst layers, configured accordant to principles of the disclosure.

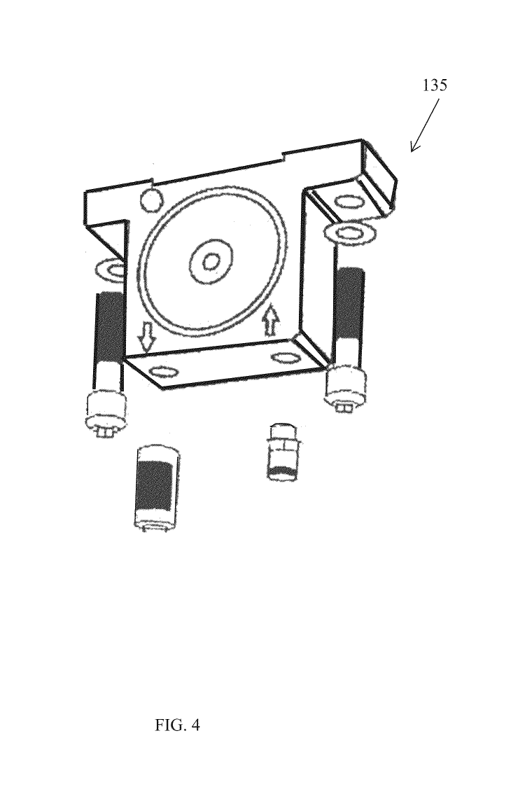

FIG. 5 is a drawing of an SCR reactor showing example locations where vibrators may be placed under catalyst layers, configured accordant to principles of the disclosure.

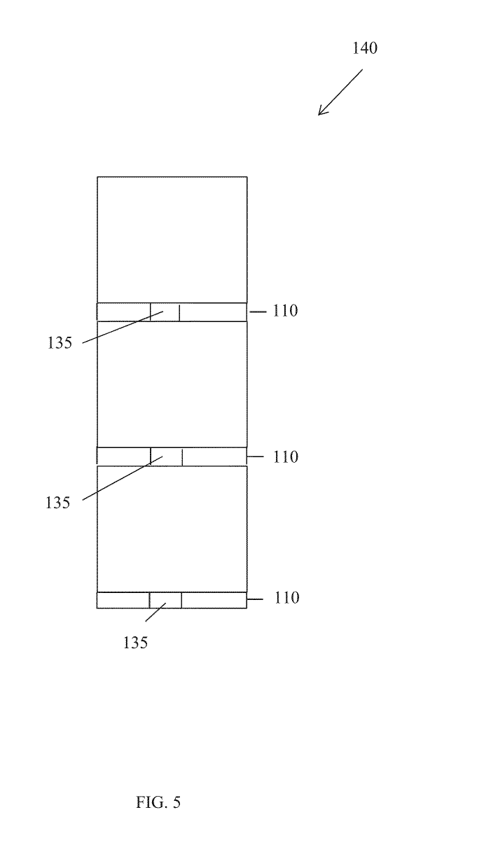

### DETAILED DESCRIPTION OF THE DISCLOSURE

The disclosure and the various features and advantageous details thereof are explained more fully with reference to the non-limiting embodiments and examples that are described and/or illustrated in the accompanying drawings and detailed in the following description. It should be noted that the features illustrated in the drawing are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure. Moreover, it is noted that like reference numerals represent similar parts throughout the several views of the drawings.

The terms “including”, “comprising” and variations thereof, as used in this disclosure, mean “including, but not limited to”, unless expressly specified otherwise.

The terms “a”, “an”, and “the”, as used in this disclosure, means “one or more”, unless expressly specified otherwise. The term “about” means within +/−10% unless context indicates otherwise.

Devices that are in communication with each other need not be in continuous communication with each other, unless expressly specified otherwise. In addition, devices that are in communication with each other may communicate directly or indirectly through one or more intermediaries.

Although process steps, method steps, algorithms, or the like, may be described in a sequential order, such processes, methods and algorithms may be configured to work in alternate orders. In other words, any sequence or order of steps that may be described does not necessarily indicate a requirement that the steps be performed in that order. The steps of the processes, methods or algorithms described herein may be performed in any order practical. Further, some steps may be performed simultaneously.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

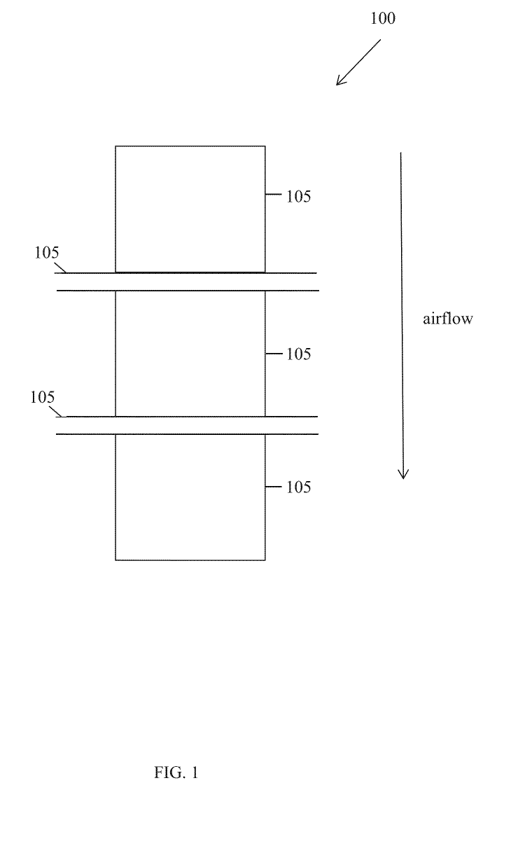

Referring now to FIG. 1 there is illustrated an example SCR unit 100 as it may appear when attached to, e.g., a coal-fired power plant. Arrow illustrates air flow through one or more layers of catalyst module 110. There may be one or more modules 110 of catalyst placed together to form a layer of catalyst within the SCR unit 100, as illustrated in FIG. 1. Also, as seen in FIG. 1, there may be I -beam supports 110, or similar support structures, under each layer of catalyst.

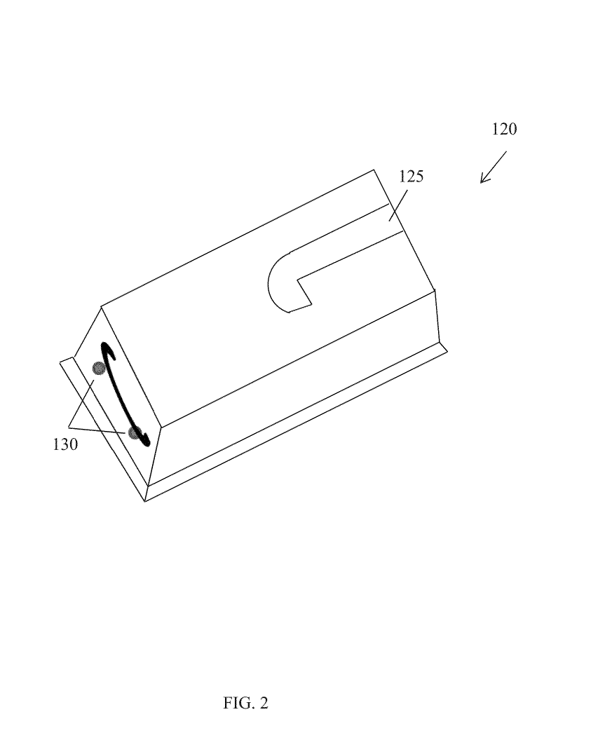

Once safely inside the SCR unit 100, entry technicians may vacuum off the fly ash that may be piled on top the catalyst. After loose ash is vacuumed, the pneumatic vibrators 135 may be secured to the I-beam structure 110 under the catalyst. Entry technicians, or the like, may then apply the specialty designed hood 120 shown in FIG. 2 to the top of each catalyst 110 basket. The vacuum line 125 going into the top of the hood 120 to vacuum the ash that may be clogged-up within the catalyst module 110. Air lines (not shown) may connect to air vents 130 going into the hood 120 to blow down the ash that is clogged-up within the catalyst module 110.

The steps of a method according to principles of the disclosure may include applying the hood 120, (which may blow air at high volume and may vacuum the tops of the catalyst), and attaching and activating the vibrators, (which shake the ash loose from beneath the catalyst modules 110). With the exception of the hood 120 and the vibrators 135, the equipment used is typically readily available for use in other industrial applications. As for the hood, it may be configured to vary in size to fit the catalyst baskets, as commonly employed in the industry. The hood 120 may have one 4-6″ opening for the vacuum line and four fittings (the number of fittings may vary) for the air pressure lines. Under the hood there may be four pipes running from each air line distributing the air pressure directly to the catalyst module 110. However, this disclosure uses the hood configuration to blow and vacuum the ash from the top of the catalyst while pneumatic vibrators 135 may be used to shake the ash loose from within the catalyst module 105 from the bottom of the modules 105.

In one example, the present disclosure includes a method of in-situation vibration cleaning of SCR catalyst within coal-fired boilers employing this blow-down/shake-down method using air and vacuum from the top of the catalyst and pneumatic vibration from the bottom. Both the hood and the vibrators can be used together or separately to produce better cleaning of the catalyst over conventional in situation methods.

While the foregoing written description enables one of ordinary skill to make and use what is considered presently to be the best mode thereof, those of ordinary skill will understand and appreciate the existence of variations, combinations and equivalents of the specific method, and examples herein. The disclosure should therefore not be limited by the above described embodiment, method, and examples, but by all examples and methods within the scope and spirit of the invention as claimed.

What is claimed:

1. A method for cleaning a selective catalytic reduction (SCR) unit, the method comprising the steps of:
positioning a hood above a catalyst module, the hood configured to blow air and configured to vacuum a top of the catalyst module; and
connecting a pneumatic vibrator under the catalyst module,
wherein the hood and pneumatic vibrator operationally clear the catalyst module of built-up particle ash.

2. A system for cleaning a selective catalytic reduction (SCR) unit, comprising:
a hood configured to be positioned above one or more catalyst modules;
a pneumatic vibrator configured to be connected under the one or more catalyst modules, wherein the hood is configured to apply air pressure to clean the one or more catalyst modules while the pneumatic vibrator is configured to simultaneously vibrate the one or more catalyst modules for cleaning the SCR unit.
